(19) United States
(12) Patent Application Publication
(10) Pub. No.: US 2024/0181411 A1
(43) Pub. Date: Jun. 6, 2024

(54) DISSOLVER CAPABLE OF INCREASING DISSOLUTION RATE

(71) Applicant: Shandong Laiwei New Materials Co., Ltd, Jinan (CN)

(72) Inventors: Yi Ren, Jinan (CN); Xiulun Wu, Jinan (CN); Xiaoying Bu, Jinan (CN)

(73) Assignee: Shandong Laiwei New Materials Co., Ltd, Jinan (CN)

(21) Appl. No.: 18/491,862

(22) Filed: Oct. 23, 2023

(30) Foreign Application Priority Data
Dec. 5, 2022 (CN) 2022115452063

(51) Int. Cl. B01F 35/71; B01F 21/00; B01F 21/10; B01F 27/906

(52) U.S. Cl. CPC B01F 35/718051; B01F 21/10; B01F 21/15; B01F 27/906

(57) ABSTRACT

A dissolver capable of increasing the dissolution rate, includes a tank body, a feeding pipe, a connecting moveable rod, and a moveable disc, the feeding pipe is communicated with the tank body, and being configured to flow raw materials into the tank body. The connection movable plate is slidably mounted inside the feeding pipe, the raw materials flows into the tank body or is prevented flowing when the connection movable plate slides from an inner front side to an inner rear side of the feeding pipe. The connecting moveable rod, provided with an end inserted into the feeding pipe to connect to the connection moveable plate, and the other end exposed outside the feeding pipe. The moveable disc is connected to the other end of the connecting moveable rod, and driven to rotate and enable the connection movable plate slide inside of the feeding pipe.

### CROSS REFERENCE TO RELATED APPLICATION

This non-provisional patent application claims priority under 35 U. S. C. § 119 from Chinese Patent Application No. 202211545206.3 filed on Dec. 5, 2022, the entire content of which is incorporated herein by reference.

### TECHNICAL FIELD

The disclosure relates to ultra high molecular weight polyethylene fiber (UHMWPEF) technologies, and in particular to a dissolver capable of increasing dissolution rate.

### BACKGROUND

Ultra-high molecular weight polyethylene fiber (UHMWPEF) also known as high strength high modulus polyethylene fiber (HSHMPE), is the fiber with the highest specific strength and specific modulus in the world. A dissolver refers to a device that can disperse a solute evenly in a solvent. The use of the dissolver required for fiber preparation requires the use of a stirring structure, which can increase the dissolution rate of UHMWPE fibers.

However, most of the dissolvers still have some defects during use. It is necessary to weigh the weight of raw materials and then pour the raw materials into the dissolver, which is time-consuming and laborious. At the same time, a typical dissolver is not effective in discharging the dissolved items, and the stirring between the raw materials and the solution is not uniform enough.

Therefore, there is a room for improving the dissolvers.

### SUMMARY

The purpose of the present invention is to provide a dissolver capable of increasing the dissolution rate, so as to solve the problem in the above-mentioned background art that the weight of the raw materials needs to be weighed and then poured into the typical dissolver during the use of the typical dissolver, which is time-consuming and laborious. The typical dissolver is not effective in discharging the dissolved objects, and the stirring between the raw material and the solution is not uniform enough.

In order to achieve the above object, a dissolver capable of increasing the dissolution rate is provided. The dissolver includes a tank body, a feeding pipe, a connecting moveable rod, and a moveable disc, the feeding pipe is communicated with the tank body, and being configured to flow raw materials into the tank body. The connection movable plate is slidably mounted inside the feeding pipe, the raw materials flows into the tank body or is prevented flowing when the connection movable plate slides from an inner front side to an inner rear side of the feeding pipe. The connecting moveable rod, provided with an end inserted into the feeding pipe to connect to the connection moveable plate, and the other end exposed outside the feeding pipe. The moveable disc is connected to the other end of the connecting moveable rod, and driven to rotate and enable the connection movable plate slide inside of the feeding pipe.

In some embodiments, the dissolver further includes a rotating rod and a material distribution plate. The rotating rod is rotatably mounted inside of the tank body, one end of the rotating rod is adjacent to the upper end of the tank body, and the other end of the rotating rod is adjacent to the lower end of the tank body. The material distribution plate is secured to the one end of the rotating rod and rotating with the rotating rod, the material distribution plate defining a plurality of dispersion holes, the raw materials flowing from the feeding pipe to the material distribution plate and dispersed under a rotation of the material distribution plate.

In some embodiments, the plurality of dispersion holes are arranged evenly.

In some embodiments, a rear end of the connection movable plate is contacted with an inner rear side of the feeding pipe to enable the raw materials to be prevented from flowing into the tank body, and separated from the rear side of the feeding pipe to enable the raw materials to flow into the tank body.

In some embodiments, the material distribution plate has a U shape longitudinal section.

In some embodiments, the dissolver further includes a stirring rod, the stirring rod is connected to a lower end of the rotating rod, and rotating with the rotating rod to stir the raw materials and fluid in the tank body.

In some embodiments, the stirring rod is in a “7” shape.

In some embodiments, the feeding pipe is located at middle of an upper end of the tank body, the connection movable plate is located at one side of the feeding pipe and rotated at a upper left side of the tank body.

In some embodiments, the dissolver further includes a fixing plate mounted at an inner rear side of the tank body, an installation engagement wheel is mounted inside of the fixing plate, the rotating rod is engaged with the installation engagement wheel, the rotating rod is rotated inside of the fixing plate.

In some embodiments, the dissolver further includes a first mounting plate, a second mounting plate, a first mounting wheel, and a second mounting wheel, the second mounting wheel is connected a bottom side of the material distribution plate, an end of a link connecting rod is connected to the second mounting wheel, the first mounting wheel is connected to the other end of the link connecting rod, the second mounting plate is connected to the first mounting wheel, the first mounting plate is connected to the second mounting plate, a plurality of mixing blades are mounted inside the first mounting plate and mounted outside of the rotating rod.

In some embodiments, the dissolver further includes a discharging assembly, the discharging assembly being mounted to lower end of the tank body to discharge the dissolved objects.

In some embodiments, the dissolver further includes a discharging pipe, a connecting pipe, a fixing installation rod, and a sealing ring, the connecting pipe is placed at a lower end of the discharging pipe, and the discharging pipe is napped outside of the sealing ring, the fixing installation rod is connected to a lower end of the discharging pipe and connected to an upper end of the connecting pipe.

In some embodiments, the dissolver further includes a movable blocking plate rotatably connected to the discharging pipe, the movable blocking plate is symmetric with respect to a central line of the discharging pipe.

Compared with the prior art, the invention has the following advantages: the dissolver can improve the dissolution rate, facilitate the quantitative addition of raw materials, facilitate the uniform stirring of raw materials and solutions, thereby improving the dissolution rate, and has good discharge effect on dissolved objects.

By pouring the raw material into the connected square feed pipe, the motor drives the movable disc to rotate on the left side of the upper end of the tank body, so that the link connecting rod connected with the rotating disc rotates on the front end of the tank body. Thus, the connecting moving plate connected with the connection movable rod rotates and slides inside the connecting square feed pipe, so that the back end of the connecting moving plate is separated behind the inner side of the connecting square feed pipe, so that the raw materials inside the connecting square feed pipe enter the inside of the tank body. It is convenient for quantitative addition of raw materials.

In detail, the motor drives the installation connecting wheel to rotate inside the fixing plate, so that the rotating rod engaged with the installation connecting wheel rotates on the inner front side of the fixing plate, so that the rotating rod drives the material distribution plate to rotate, and the dispersion holes are evenly defined on the outer surface of the material distribution plate. The raw materials entering into the tank body are evenly dispersed in the lower inner side of the tank body, so that the material dispersion plate drives the second mounting wheel to rotate, and then the link connecting rod that is meshed with the second mounting wheel rotates on the inner rear side of the tank body, so that the first mounting wheel that is meshed with the link connecting rod drives the second mounting plate to rotate on the outer side of the link connecting rod. Thus, the second mounting plate drives the first mounting plate to rotate, and then the first mounting plate and the link connecting rod drive the mixing blades to rotate, which is convenient to stir the raw materials and solutions, thereby increasing the dissolution rate.

By placing the connecting pipe at the lower end of the discharging pipe, the connecting pipe is clamped on the outside of the sealing ring, rotating the fixed mounting rod, so that the fixed mounting rod is threaded on the outside of the lower end of the discharging pipe, so that the fixed mounting rod is threaded on the outside of the upper end of the connecting pipe, convenient installation of the connecting pipe, and then by starting the cylinder. The cylinder rotates inside the discharging pipe, so that the movable blocking plate connected with the cylinder rotates inside the discharging pipe, so that the liquid inside the tank body is discharged through the discharging pipe, and the discharge effect of the dissolved object is ensured.

### BRIEF DESCRIPTION OF THE DRAWINGS

FIG. 1 is a cross-section view of a dissolver in accordance to an embodiment;

FIG. 2 is a cross-section view of a connection structure of a discharging pipe and a movable blocking plate of the dissolver in accordance to an embodiment;

FIG. 3 is an enlarge view of a circle portion labeled A in FIG. 1 in accordance to an embodiment;

FIG. 4 is an enlarge view of a circle portion labeled B in FIG. 1 in accordance to an embodiment;

FIG. 5 is a side-section view of the dissolver in accordance to an embodiment;

FIG. 6 is an enlarge view of a circle portion labeled C in FIG. 5 in accordance to an embodiment;

FIG. 7 is an isometric view of the connection structure between a movable disc and a connection movable rod in accordance to an embodiment.

In the figures: 1, tank body; 2, discharging assembly; 201, discharging pipe; 202, movable blocking plate; 203, cylinder; 204, fixing installation rod; 205, sealing ring; 206, connecting pipe; 3, connection supporting plate; 4, fixing plate; 5, installation engagement wheel; 6, material distribution plate; 7, link connecting rod; 8. mixing blade; 9, rotating rod; 10, first mounting plate; 11, feeding pipe; 12, stirring rod; 13, movable connection block; 14, second mounting plate; 15, first mounting wheel; 16, second mounting wheel; 17, dispersion hole; 18, movable disc; 19, connection movable plate; 20, connection movable rod.

### DETAILED DESCRIPTION OF THE EMBODIMENTS

The following will clearly and completely describe the technical solutions in the embodiments of the present invention with reference to the accompanying drawings in the embodiments of the present invention. Obviously, the described embodiments are only some, not all, embodiments of the present invention. Based on the embodiments of the present invention, all other embodiments obtained by persons of ordinary skill in the art without making creative efforts belong to the protection scope of the present invention.

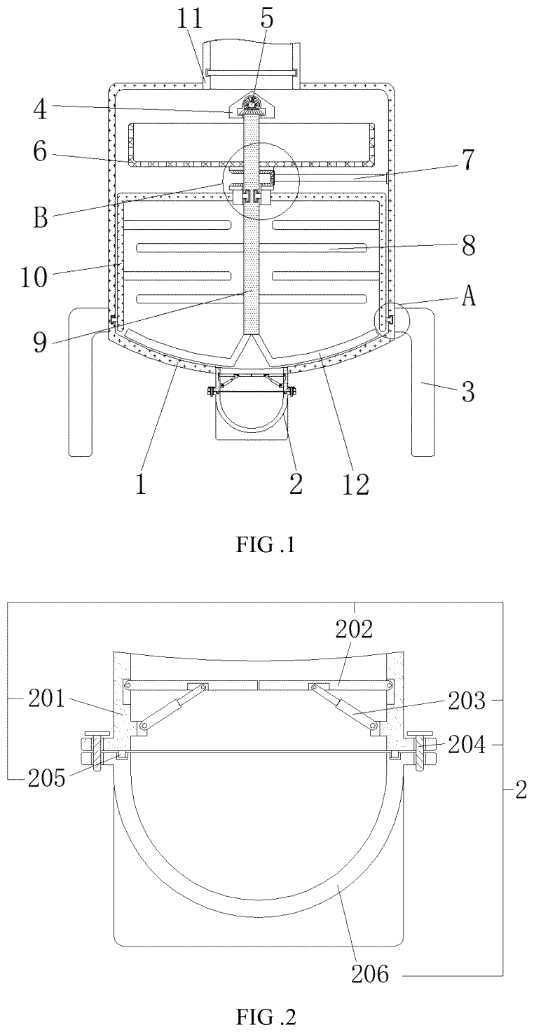

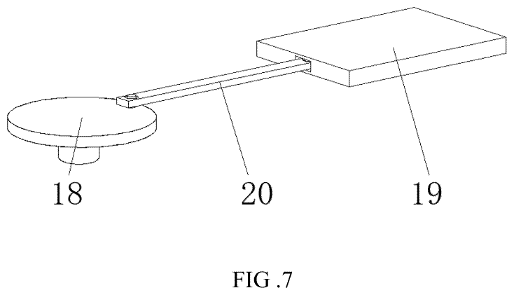

Referring to FIGS. 1-7, a dissolver capable of increasing the dissolution rate is provided. The dissolver includes a tank body 1, a discharging assembly 2 fixedly installed on middle of a lower end of the tank body 1, a connection supporting plate 3 connected to a low end of the outside of the tank body 1, a fixing plate 4 mounted inside of a back side of the tank body 1, an installation engagement wheel 5 mounted inside of the tank body 1 with the fixing plate 4, a rotating rod 9 connected to a low end of a front side of the installation engagement wheel 5. a material distribution plate 6 fixed on outside of an upper end of the installation engagement wheel 5, and dispersion holes 17 defined in the outer surface of the material distribution plate 6. Objects which is dissolved are easily discharged by mounting the discharging assembly 2 on the middle of the low end of the tank body 1. a motor drives the installation engagement wheel 5 to rotate inside of the fixing plate 4, so that the rotating rod 9 meshed with the installation engagement wheel 5 rotates in an inner front side of the fixing plate 4, and the rotating rod 9 drives material distribution plate 6 to rotate, the dispersion holes 17 are evenly defined on the outer surface of the material distribution plate 6, so that the raw materials entering into the tank body 1 are evenly dispersed on an inner lower side of the tank body 1.

The second mounting wheel 16 is fixedly connected to middle of a lower end of the material distribution plate 6, and a link connecting rod 7 is connected to a right side of a lower end of the second mounting wheel 16. A first mounting wheel 15 is engaged with a lower side of a left end of the link connecting rod 7. A first mounting plate 10 and a second mounting plate 14 are fixedly mounted together. The second mounting plate 14 is fixedly secured on a lower end of the first mounting wheel 15. The first mounting plate 10 is fixedly secured on an outer surface of the second mounting plate 14. A plurality of mixing blades 8 are respectively secured on an inner side of the first mounting plate 10 and an outer surface of a middle portion of the rotating rod 9. A movable connection block 13 is fixedly installed on the outer side of the lower end of the first mounting plate 10, and a stirring rod 12 is fixedly connected to the lower end of the rotating rod 9, so that the material distribution plate 6 drives the second mounting wheel 16 to rotate, and then make the link connecting rod 7 engaged with the second mounting wheel 16 rotate at an inner rear side of the tank body 1, so that the first mounting wheel 15 meshing and connecting with the link connecting rod 7 drives the second mounting plate 14 to rotate at the outer side of rotating rod 9, so that the second mounting plate 14 drives the first mounting plate 10 to rotate, and then both the first mounting plate 10 and the rotating rod 9 drive the mixing blades 8 to rotate, which is convenient to stir raw materials and solution and increase the dissolution rate. Further, the stirring rod 12 is driven to rotate by the rotating rod 9 that the stirring rod 12 can stir the objects on the lower side of the tank body 1.

A feeding pipe 11 is fixedly connected to middle of an upper end the tank body 1. In this embodiment, the feeding pipe 11 is a quadrate pipe, and can be called a quadrate feeding pipe. In some other embodiment, the feeding pipe 11 maybe but not limited to be a circular pipe. A movable disc 18 is rotatably connected to a front side of the upper end of the tank body 1. A connection movable rod 20 is rotatably connected to a right side of an upper end of the movable disc 18. A connection movable plate 19 is rotatably connected to the right end of the connection movable rod 20. When pouring the raw materials inside of the feeding pipe 11, the motor drives the movable disc 18 to rotate on the left side of the upper end of the tank body 1, so that the connection movable rod 20 connected with the movable disc 18 is rotated in the front end of the upper end of the tank body 1, and the connection movable plate 19 rotatably connected with the connection movable rod 20 slides inside the feeding pipe 11, and then the rear end of the connection movable plate 19 connected to the feeding pipe 11 is separated from the internal rear side of the feeding pipe 11. As a result, the raw materials located inside of the feeding pipe 11 enters inside of the tank body 1, so that the raw materials can be added quantitatively.

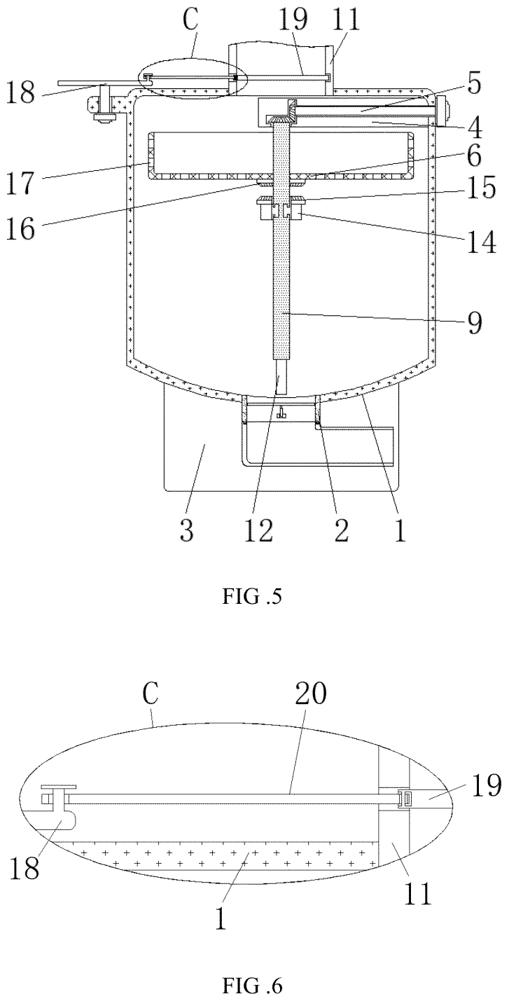

When using the dissolver that can improve the dissolution rate, specifically as shown in FIGS. 5, 6 and 7, the raw materials are poured inside of the feeding pipe 11, and the motor drives the movable disc 18 to rotate on the left side of the upper end of the tank body 1. Further, the moving plate 19 is slidably connected with the feeding pipe 11 to play a blocking effect on the raw materials, and the movable rod 20 rotatably connected to the rotating disc 18 rotates at the front side of the upper end of the tank body 1, so that the connection movable plate 19 rotatably connected with the connection movable rod 20 slides inside of the feeding pipe 11, and then the rear end of the connection movable plate 19 is separated from an inner rear side of the feeding pipe 11, so that the raw materials located inside of the feeding pipe 11 enter inside of the tank body 1 that the raw materials can be added quantitatively.

Referring FIGS. 1, 4 and 5, in detail, the motor drives the installation engagement wheel 5 to rotate inside of the fixing plate 4, the installation engagement wheel 5 and the rotating rod 9 are connected in a meshing manner, and the rotating rod 9 and the fixing plate 4 are rotated. The rotating rod 9 engaged with the installation engaging wheel 5 rotates at the inner front side of the fixing plate 4, so that the rotating rod 9 drives the material distribution plate 6 to rotate, and the dispersion holes 17 in the outside of the material distribution plate 6 is evenly arranged, and a vertical section of the material distribution plate 6 is a “U”-shaped, so that the dispersion holes 17 uniformly defined in the outer surface of the material distribution plate 6 can evenly scattered the raw materials, entering inside of the tank body 1 on the inner lower side of the tank body 1. Further, the material distribution plate 6 drives the second mounting wheel 16 to rotate, and the link connecting rod 7 and the second mounting wheel 16 are connected in an engaging manner, and the link connecting rod 7 is connected an inner side of the tank body 1 via a bearing, and then the link connecting rod 7 engaged with the second mounting wheel 16 is rotated on the inner rear side of the tank body 1. The second installing plate 14 and the rotating rod 9 are connected in a rotating manner and plays an active role on the first mounting plate 10, so that the first mounting wheel 15 engaged with the link connecting rod 7 drives the second mounting plate 14 to rotate on the outside of the rotating rod 9, so that the second mounting plate 14 drives the first mounting plate 10 to rotate, and then the first mounting plate 10 and the rotating rod 9 all drive the mixing blades 8 to rotate.

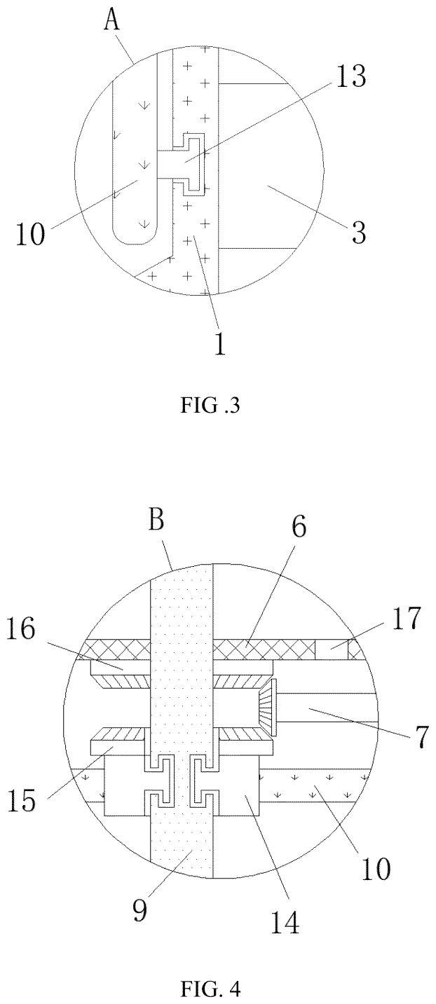

Referring to FIG. 3, the first mounting plate 10 drives the movable connection block 13 to rotated inside the tank body 1, which is convenient for stirring the raw materials and the solution, and increases the dissolution rate. The vertical section of the stirring rod 12 is in “7” shaped. A left and right sides of the stirring rod 12 are symmetrical with respect to central line. The stirring rod 12 is driven to rotate by connecting the rotating rod 9, so that the stirring rod 12 can stir the solution and raw materials in the lower side of the tank body 1, it ensures the improvement of the dissolution rate.

Referring to FIG. 1, FIG. 2 and FIG. 5, in detail, a connecting pipe 206 is placed on the lower end of the discharging pipe 201, so that the connecting pipe 206 is engaged and connected on the outside of the sealing ring 205, and a threaded connection is adopted between the fixing installation rod 204 and the connecting pipe 206. The connecting pipe 206 is connected with the sealing ring 205 by means of engagement, and the fixing installation rod 204 is rotated so that the fixing installation rod 204 is threaded on the outside of the lower end of the discharging pipe 201, so that the fixing installation rod 204 is threaded on the outer side of the upper end of connecting pipe 206 to facilitate the installation of connecting pipe 206. A movable blocking plate 202 is connected with the discharging pipe 201 in a rotating manner, and the movable blocking plate 202 is connected with the discharging pipe 201. The left and right sides of the movable blocking plate 202 are symmetrical with respect to the central line of the discharging pipe. A cylinder 203 is rotated inside the discharging pipe 201 by starting the cylinder 203, so that the movable blocking plate 202 connected to the cylinder 203 rotates inside the discharging pipe 201. The liquid inside of the the tank body 1 flows out through the discharging pipe 201, which ensures a good discharge effect on the dissolved objects.

The standard parts used in the present invention can be purchased from the market, and the special-shaped parts can be customized according to the instructions and the records of the accompanying drawings. The specific connection methods of each part adopt mature bolts, rivets, welding, etc. in the prior art. Conventional means, machinery, parts and equipment all adopt the conventional models in the prior art, plus the circuit connection adopts the conventional connection methods in the prior art, which will not be described in detail here, and the content that is not described in detail in this manual belongs to prior art known to those skilled in the art.

Although the present invention has been described in detail with reference to the aforementioned embodiments, those skilled in the art can still modify the technical solutions described in the aforementioned embodiments, or perform equivalent replacements for some of the technical features. Within the spirit and principles of the present invention, any modifications, equivalent replacements, improvements, etc., shall be included in the protection scope of the present invention.

1. A dissolver capable of increasing the dissolution rate, comprising:
a tank body;
a feeding pipe, communicated with the tank body, and being configured to flow raw materials into the tank body;
a connection movable plate, slidably mounted inside the feeding pipe, the raw materials flowing into the tank body or being prevented flowing when the connection movable plate slides from an inner front side to an inner rear side of the feeding pipe;
a connecting moveable rod, with an end inserted into the feeding pipe to connect to the connection moveable plate, and the other end exposed outside the feeding pipe; and
a moveable disc, connected to the other end of the connecting moveable rod, the moveable disc being driven to rotate and enable the connection movable plate slide inside of the feeding pipe.

2. The dissolver of claim 1, further comprising:
a rotating rod, rotatably mounted inside of the tank body, one end of the rotating rod adjacent to the upper end of the tank body, and the other end of the rotating rod adjacent to the lower end of the tank body; and
a material distribution plate, secured to the one end of the rotating rod and rotating with the rotating rod, the material distribution plate defining a plurality of dispersion holes, the raw materials flowing from the feeding pipe to the material distribution plate and dispersed under a rotation of the material distribution plate.

3. The dissolver of claim 2, wherein the plurality of dispersion holes are arranged evenly.

4. The dissolver of claim 1, wherein a rear end of the connection movable plate is contacted with an inner rear side of the feeding pipe to enable the raw materials to be prevented from flowing into the tank body, and separated from the rear side of the feeding pipe to enable the raw materials to flow into the tank body.

5. The dissolver of claim 1, wherein the material distribution plate has a U shape longitudinal section.

6. The dissolver of claim 1, further comprising a stirring rod, the stirring rod being connected to a lower end of the rotating rod, and rotating with the rotating rod to stir the raw materials and fluid in the tank body.

7. The dissolver of claim 6, wherein the stirring rod is in a “7” shape.

8. The dissolver of claim 1, wherein the feeding pipe is located at middle of an upper end of the tank body, the connection movable plate is located at one side of the feeding pipe and rotated at a upper left side of the tank body.

9. The dissolver of claim 1, further comprising a fixing plate mounted at an inner rear side of the tank body, an installation engagement wheel being mounted inside of the fixing plate, the rotating rod being engaged with the installation engagement wheel, the rotating rod being rotated inside of the fixing plate.

10. The dissolver of claim 1, further comprising a first mounting plate, a second mounting plate, a first mounting wheel, and a second mounting wheel, the second mounting wheel being connected a bottom side of the material distribution plate, an end of a link connecting rod being connected to the second mounting wheel, the first mounting wheel is connected to the other end of the link connecting rod, the second mounting plate being connected to the first mounting wheel, the first mounting plate being connected to the second mounting plate, a plurality of mixing blades being mounted inside the first mounting plate and mounted outside of the rotating rod.

11. The dissolver of claim 1, further comprising a discharging assembly, the discharging assembly being mounted to lower end of the tank body to discharge the dissolved objects.

12. The dissolver of claim 1, further comprising a discharging pipe, a connecting pipe, a fixing installation rod, and a sealing ring, the connecting pipe being placed at a lower end of the discharging pipe, and the discharging pipe being napped outside of the sealing ring, the fixing installation rod being connected to a lower end of the discharging pipe and connected to an upper end of the connecting pipe.

13. The dissolver of claim 12, further comprising a movable blocking plate rotatably connected to the discharging pipe, the movable blocking plate being symmetric with respect to a central line of the discharging pipe.

14. The dissolver of claim 13, further comprising a cylinder connected to the movable blocking plate and driving the movable blocking plate to rotate in the discharging pipe, and enable the fluid flow out of the discharging pipe.

15. The dissolver of claim 14, wherein the fixing installation rod provides with two ends respectively engaged with the discharging pipe and the connecting pipe.

16. The dissolver of claim 1, wherein the feeding pipe is a square pipe.

17. A dissolver capable of increasing the dissolution rate, comprising:
a tank body;
a feeding pipe, communicated with the tank body, and being configured to flow raw materials into the tank body;
a rotating rod, rotatably mounted inside of the tank body, one end of the rotating rod adjacent to the upper end of the tank body, and the other end of the rotating rod adjacent to the lower end of the tank body; and
a material distribution plate, secured to the one end of the rotating rod and rotating with the rotating rod, the material distribution plate defining a plurality of dispersion holes, the raw materials flowing from the feeding pipe to the material distribution plate and dispersed under a rotation of the material distribution plate.

18. The dissolver of claim 17, wherein the plurality of dispersion holes are arranged evenly.

19. The dissolver of claim 18, further comprising a stirring rod, the stirring rod being connected to a lower end of the rotating rod, and rotating with the rotating rod to stir the raw materials and fluid in the tank body.

20. The dissolver of claim 19, wherein the stirring rod is in a “7” shape.
